(19) United States
(12) Patent Application Publication
(10) Pub. No.: US 2006/0128195 A1
(43) Pub. Date: Jun. 15, 2006

(54) Switch connector

(75) Inventor: Kun Hua Chen, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/304,525

(22) Filed: Dec. 14, 2005

(30) Foreign Application Priority Data
Dec. 14, 2004 (CN) 200420054460.4

(51) Int. Cl. H01R 29/00

(52) U.S. Cl. 439/188

(57) ABSTRACT

A switch connector includes an insulative housing (1), a fixed terminal (2), a switch terminal (3) and a shielding (4). The insulative housing has a base portion (10) defining a hollow portion (12) and a pair of notches (16, 16′) on the bottom thereof, and a cylindrical introduction portion (11) upwardly extending from the base portion. The fixed terminal has a pair of first fixed portions (22) retained in the hollow portion and a U-shaped portion (23) retained in one of the pair of notches. The switch terminal has a second fixed portion (32) retained in the hollow portion and a U-shaped portion (33) retained in another notch. The shielding encloses the cylindrical introduction portion and the base portion of the insulative housing. An electrical connection between the fixed terminal and the switch terminal is obtained by a contact at a point.

### BACKGROUND OF THE INVENTION

1. Field of the Invention

The present invention relates to a switch connector, and more particularly to a radio frequency switch connector for sensitively switching electrical signal.

2. Description of the Prior Art

Nowadays, a switch connector having a signal-switching circuit is widely used in mobile electrical devices. The conventional switch connector commonly comprises an insulative housing, a shielding enclosing the insulative housing, and a fixed terminal and a movable terminal, both of which are retained in the insulative housing, and in their normally closed state, contact with one another. When a mating connector perpendicularly inserts into the conventional switch connector, an end of the movable terminal disconnects from the fixed terminal under a press force.

Such a switch connector is disclosed in U.S. Pat. No. 6,783,374. The movable terminal includes a movable contact portion which is configured to have a spring-movable function. When the mating coaxial connector is not mounted, the movable contact portion bulges upward at an approximate central portion thereof. In contrast, when the mating coaxial connector is mounted, the approximate central portion of the movable contact portion is pushed downward by a central contact of the mating connector. The approximate central portion of the movable contact portion is reversed and the approximated central portion thererof takes an arcuate shape with the approximate central portion thereof bulged downward. Thus, the movable contact portion can be bulged upwards to establish an electrical connectivity between the movable terminal and the fixed terminal, or bulged downwards to disconnect the connection therebetween. The repeated connections or disconnections between the movable terminal and the mating connector need the movable contact portion, especially the approximated central portion of the movable contact portion have good resilient characteristic. However, the purchase cost of such resilient material is high.

A contact area between the mating connector and the movable contact portion is rarely small. During practical operation, a problem raises that the disconnect between the movable terminal and the fixed terminal is incomplete because the contact area is relatively long and discrete. Thus, the mating connector needs to be pushed again to completely disconnect the electrical connectivity between the movable terminal and the fixed terminal. Accordingly, this disadvantage cannot be acceptable in mobile electrical devices that need very high speed of signal handing.

Hence, an improved switch connector is needed to solve the above problems.

### BRIEF SUMMARY OF THE INVENTION

An object of the invention is to provide a switch connector with low cost which switches electrical signal rapidly and completely.

In order to attain the object above mentioned, a switch connector A switch connector includes an insulative housing, a fixed terminal, a switch terminal and a shielding. The insulative housing has a base portion defined a hollow portion and a pair of notches on the bottom thereof, and a cylindrical introduction portion upwardly extending from the base portion. The fixed terminal has one end retained in the hollow portion and another end retained in one of the pair of notches. The switch terminal has one end retained in the hollow portion and another end retained in another notch. The shielding encloses the cylindrical introduction portion and the base portion of the insulative housing. An electrical connection between the fixed terminal and the switch terminal is obtained by a contact at a point.

Other objects, advantages and novel features of the invention will become more apparent from the following detailed description of the present embodiment when taken in conjunction with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a exploded view of a switch connector of the present invention;

FIG. 2 is an another exploded view of the switch connector shown in FIG. 1;

FIG. 3 is an assembled view of the switch connector shown in FIG. 1;

FIG. 4 is an another assembled view of the switch connector shown in FIG. 1;

FIG. 5 is a sectional view of the switch connector taken along line 5-5 in FIG. 3 before a mating connector inserted thereinto; and

FIG. 6 is a sectional view of the switch connector taken along line 5-5 in FIG. 3 showing the mating connector is inserted.

### DETAILED DESCRIPTION OF THE INVENTION

Reference will now be made to the drawing figures to describe the present invention in detail.

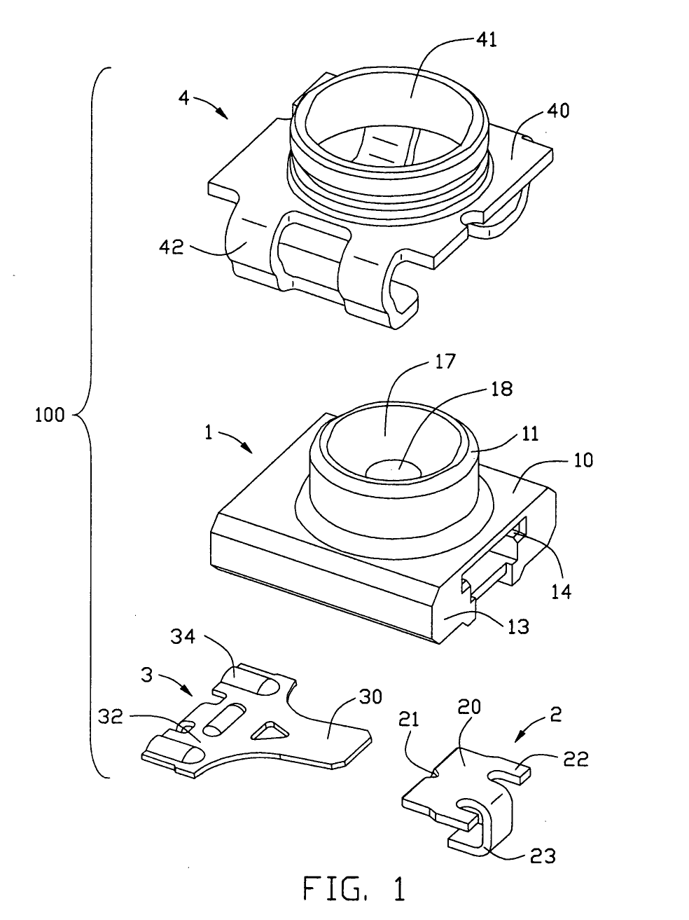

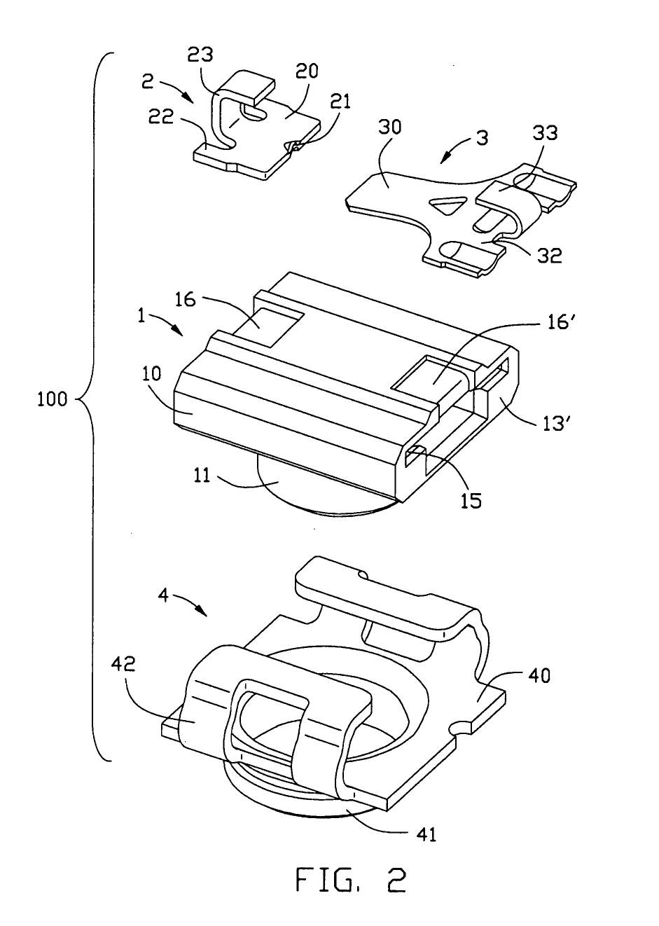

Referring to FIGS. 1, 2, 3, and 4, a switch connector 100 comprises a insulative housing 1, a fixed terminal 2, a switch terminal 3 and a shielding 4.

The insulative housing 1 comprises a base portion 10 having a cuboid shape and a cylindrical introduction portion 11 extending upwardly and perpendicularly from a approximate central portion on an upper surface of the base portion 10. The base portion 10 comprises a pair of lateral walls 13 and 13′, a hollow portion 12 passed through the lateral walls 13 and 13′, a pair of fixing slots 14 and 15 provided at a inside surface of the hollow portion 12 which are respectively extends from the lateral walls 13 and 13′, and a pair of notches 16 and 16′ defined on the bottom of the opposite two lateral walls 13 and 13′ of the cuboid base portion 10. The cylindrical introduction portion 11 defines an inner wall 17 having a cone shape and a through hole 18 extending downwardly and perpendicularly from a center of an upper surface of the cylindrical introduction portion 11 to the hollow portion 12.

The fixed terminal 2 comprises a first contact portion 20 defined a contacting point 21 or a dimple on an edge thereof, a pair of first fixed portions 22 extending along a direction opposite to the edge of the first contact portion 20, and a U-shaped portion 23 extending between the pair of first fixed portions 22.

The switch terminal 3 comprises a second contact portion 30, a second fixed portion 32 extending from the second contact portion 30 with a spring function, which is wider than the second contact portion 30, and a U-shaped portion 33 connecting to the second fixed portion 32. In addition, a plurality of strengthened ribs 34 are defined on an upper surface of the second fixed portion 32 to increase security of the switch terminal 3 in the insulative housing 1.

The shielding 4 comprises a body portion 40, a cylindrical portion 41 extending upwardly from the body portion 40 to enclose the cylindrical introduction portion 11 of the insulative housing 1, and a pair of flanges 42 extending from the body portion 40 outwardly and then inwardly. The flanges 42 are bent to partially enclose the base portion 10 of the insulative housing 1.

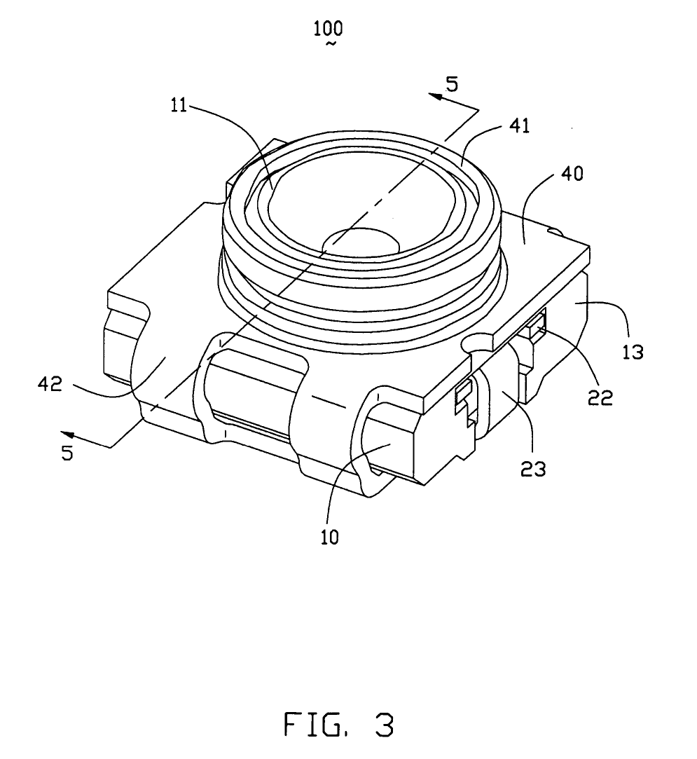

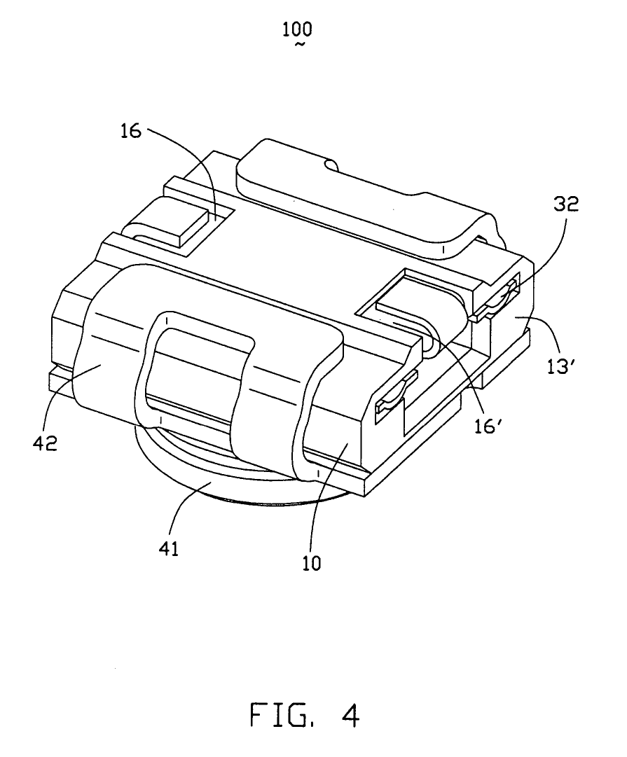

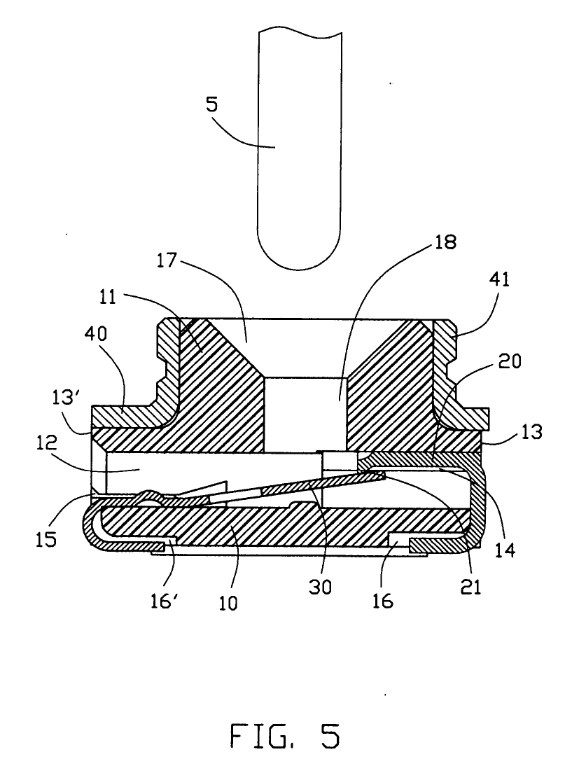

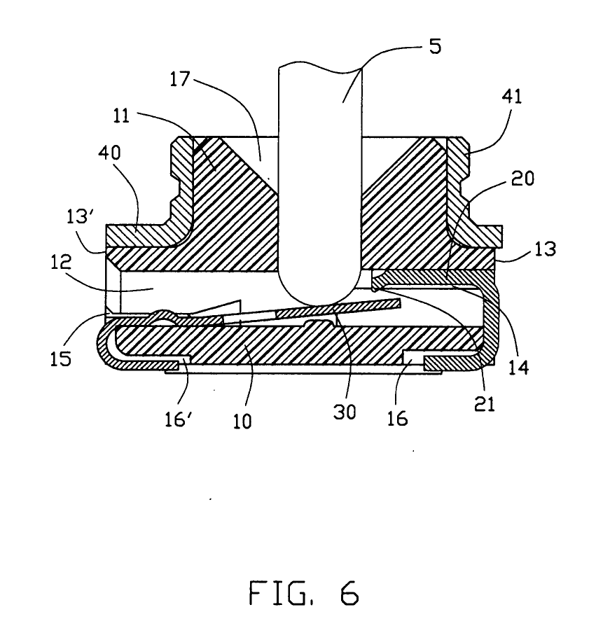

Referring to FIGS. 5 and 6, in conjunction with FIGS. 3 and 4, the fixed terminal 2 and the switch terminal 3 are respectively assembled to the base portion 10 and extend with the hollow portion 12 of the base portion 10. An electrical connection is established between the fixed terminal 2 and the switch terminal 3 via engagement between the first contact portion 21 and the second contact portion 30. The fixed terminal 2 is retained in the fixing slot 14 with the pair of first fixed portions 22 abutting against opposite inner faces of the slot 14. The U-shaped portion 23 project outside the lateral wall 13 with a lower end thereof being retained in the notch 16 for surface-mounted to a substrate (not shown) on which a high frequency circuit is provided.

At the same time, the second fixed portion 32 of the switch terminal 3 is retained in the fixing slot 15, and the second contact portion 30 is retained in the hollow portion 12. One end of the U-shaped portion 33 extends outside the lateral wall 13′, and the other end is retained in the slot 16′. A front portion of the second contact portion 30 resiliently contacts with the contacting point 21. The cylindrical portion 41 of the shielding 4 is assembled to the cylindrical introduction portion 11. The body portion 40 is attached to the surface of the base portion 10 and the flanges 42 enclose the base portion 10 to secure the shielding 4 on the insulative housing 1.

In an alternative embodiment, the contacting point 21 may be defined on the second contact portion 30, which is used for contacting with the first contact portion 20.

Before a contact 5 of mating connector inserts into the switch connector 100, the second contact portion 30 resiliently contacts with the contacting point 21. When the contact 5 is pushed to press the second contact portion 30 through the cylindrical introduction portion 11, the second contact portion 30 disconnects from the contacting point 21 quickly. In the present invention, the connection between the switch terminal 3 and the fixed terminal 2 is established in a point-contacting manner. This manner effectively avoids incompletely disconnect that raises metallic impurity produced during manufacturing. In addition, the point contacting manner is a help to switch signal rapidly. It should be noted here that compared to the conventional art, the contact having point-contact structure is relatively easy to produce and whereby the cost is reduced.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. A switch connector comprising:
an insulative housing having a base portion defining a hollow portion and a pair of notches on the bottom thereof, and a cylindrical introduction portion upwardly extending from the base portion;
a fixed terminal having one end retained in the hollow portion and another end retained in one of the pair of notches;
a switch terminal having one end retained in the hollow portion and another end retained in another one of the pair of notches; and
a shielding enclosing the cylindrical introduction portion and the base portion of the insulative housing;
wherein an electrical connection between the fixed terminal and the switch terminal is obtained by contacting each other at a point.

2. The switch connector according to claim 1, wherein the fixed terminal has a first contact portion and a contact point defined on an edge of the first contact portion thereof.

3. The switch connector according to claim 2, wherein the contact point is configured as a dimple protruded toward the switch terminal.

4. The switch connector according to claim 1, wherein the switch terminal has a second contact portion and a contact point defined on an edge of the second contact portion thereof.

5. The switch connector according to claim 4, wherein the contact point is configured as a dimple protruded toward the fixed terminal.

6. The switch connector according to claim 2, wherein the fixed terminal comprises a pair of first fixed portions extending along a direction opposite to the edge of the first contact portion, and a U-shaped portion extending between the pair of first fixed portions.

7. The switch connector according to claim 1, wherein the switch terminal comprises a second fixed portion extending from the second contact portion, and a U-shaped portion connecting to the second fixed portion.

8. The switch connector according to claim 7, wherein the switch terminal comprises a plurality of strengthened ribs defined on an upper surface of the second fixed portion thereof.

9. The switch connector according to claim 1, wherein the cylindrical introduction portion of the insulative housing defines an inner wall having a cone shape.

10. The switch connector according to claim 1, wherein the cylindrical introduction portion of the insulative housing comprises a through hole extending along a direction perpendicular to a lengthwise direction of the hollow portion.

11. The switch connector according to claim 1, wherein the shielding comprises a body portion, a cylindrical portion extending upwardly from the body portion to enclose the cylindrical introduction portion of the insulative housing, and a pair of flanges.

12. The switch connector according to claim 11, wherein the flanges extend from the body portion outwardly and then inwardly, which are bent to partially enclose the base portion of the insulative housing.

13. A switch connector comprising:
an insulative one-piece housing having a base portion defining a hollow portion and a pair of opposite notches on the bottom thereof, and a cylindrical introduction portion upwardly extending from the base portion;
a fixed terminal being laterally and inwardly inserted into the hollow portion with one end retained in the hollow portion and another end retained in one of the pair of notches;
a switch terminal being laterally and inwardly inserted into the hollow portion with one end retained in the hollow portion and the other end retained in the other of the pair of notches; and
a shielding downwardly assembled to the housing and enclosing the cylindrical introduction portion and the base portion of the insulative housing.

14. The switch connector as claimed in claim 13, wherein an electrical connection between the fixed terminal and the switch terminal is obtained by contacting each other at a point.

15. The switch connector as claimed in claim 14, wherein one of said fixed terminal and said switch terminals forms a bulge for contact the other in a single point manner.
